(19) United States
(12) Patent Application Publication
(10) Pub. No.: US 2008/0053179 A1
(43) Pub. Date: Mar. 6, 2008

(54) CLAMPING SLEEVE AND APPARATUS FOR FORMING THE SAME

(76) Inventor: Chien-Chen Teng, Chia Yi City (CN)

Correspondence Address: STITES & HARBISON PLLC, 1199 NORTH FAIRFAX STREET, SUITE 900, ALEXANDRIA, VA, 22314, US

(21) Appl. No.: 11/470,315

(22) Filed: Sep. 6, 2006

(51) Int. Cl. B21D 1/00; B29C 35/00

(52) U.S. Cl. 72/293; 425/451.9; 425/47

(57) ABSTRACT

A clamping sleeve for a shelf includes an intermediate neck portion and two open ends. The clamping sleeve is formed by pressing a metal plate, with an outwardly tapering conic coupling portion formed between the intermediate neck portion and each open end. A method and an apparatus for forming such a clamping sleeve are also disclosed.

### BACKGROUND OF THE INVENTION

1. Field of the Invention

The present invention relates to a clamping sleeve and, more particularly, to a clamping sleeve for a shelf. The present invention also relates to an apparatus and a method for forming such a clamping sleeve.

2. Description of the Related Art

FIG. 1 of the drawings illustrates a conventional shelf comprising a plurality of support rods 1′, a plurality of lining rings 2′, and a plurality of support frames 3′. Each support rod 1′ includes a plurality of longitudinally spaced annular grooves 11′. Each lining ring 2′ includes two conic halves 21′ and 22′ that are assembled to form a conic member with an inner diameter that decreases upward. Each conic half 21′, 22′ has a rib 211′, 221′ on an inner periphery thereof for engaging with an associated annular groove 11′ when the lining ring 2′ is mounted around the support rod 1′. Each support frame 3′ includes four clamping sleeves 31′ respectively in four corners thereof. Each clamping sleeve 31′ is a conic member with two open ends and has an inner diameter that decreases upward, as shown in FIG. 2.

A fence 32′ is connected between a pair of clamping sleeves 31′. Articles can be placed on a support plane 33′ formed by a plurality of rods are connected between bottom ends of the fences 32′. The support frames 3′ and the support rods 1′ are fixed together by the upwardly tapering clamping sleeves 31′ mounted around the conic lining rings 2′. However, different users have different needs. Some users require the fences 32′ to prevent the articles from falling while others wish to detach the fences 32′ for a large space for placing articles. Further, the conic clamping sleeves 31′ are fixed and thus cannot be used in circumstances where pivotable clamping sleeves are required.

### SUMMARY OF THE INVENTION

An apparatus for forming a clamping sleeve for a shelf in accordance with the present invention comprises a bottom mold, a top mold, a first inner mold, and a second inner mold. The bottom mold includes a semi-circular groove in a center thereof. The semi-circular groove of the bottom mold includes two open ends and a reduced section between the open ends. The bottom mold includes two lateral sides each having an inclined face.

The top mold is placed on top of the bottom mold and includes a semi-circular groove in a center thereof. The semi-circular groove of the top mold includes two open ends and a reduced section between the open ends. The reduced section of the top mold is aligned with the reduced section of the bottom mold. The top mold includes two lateral sides each having an inclined face.

The top mold is movable to a first position in which the semi-circular grooves of the top and bottom molds together form a circle whereas the inclined faces of the top mold are engaged with the inclined faces of the bottom mold and a second position in which the semi-circular grooves of the top and bottom molds are separate from each other whereas the inclined faces of the top mold are disengaged from the inclined faces of the bottom mold.

The first inner mold is restrained in a frame and not moveable back and forth. The first inner mold includes a conic protrusion that tapers outward and that extends into the semi-circular grooves of the bottom and top molds. A front edge of the protrusion of the first inner mold rests at the reduced sections of the bottom and top molds. The first inner mold is biased by an elastic element such that a gap exists between the protrusion of the first inner mold and a circumferential wall defining the semi-circular groove of the bottom mold, allowing insertion of a front half of a U-shaped member into the gap.

The second inner mold includes a first end adjacent to the first inner mold and a second end. The first end of the second inner mold includes a conic protrusion that tapers outward. The second end of the second inner mold is engaged with an actuating rod by a pin.

When the actuating rod is moved outward, a front edge of the protrusion of the second inner mold is moved to the reduced sections of the bottom and top molds. When the actuating rod is retracted, the front edge of the protrusion of the second inner mold is disengaged from the semi-circular grooves of the bottom and top molds.

Preferably, a slide block is mounted adjacent to the protrusion of the second inner mold and has a hole in which the second inner mold is slidingly received. The slide block includes two wings respectively extending outward from two sides thereof. A slide seat has two grooves in which the wings of the slide block are respectively engaged. A lid is screwed to the slide seat for sealing the slide block. An elastic element is provided below each wing for biasing the protrusion of the second inner mold into the U-shaped member when the actuating rod is moved outward.

A method for manufacturing a clamping sleeve for a shelf in accordance with the present invention comprises pressing a metal plate into a U-shaped member with a forming machine and pressing the U-shaped member with the above-mentioned apparatus to form a clamping sleeve having an intermediate neck portion and two open ends, with an outwardly tapering conic coupling portion formed between the intermediate neck portion and each open end.

A clamping sleeve for a shelf in accordance with the present invention comprises an intermediate neck portion and two open ends. The clamping sleeve is formed by pressing a metal plate, with an outwardly tapering conic coupling portion formed between the intermediate neck portion and each open end.

Other objectives, advantages, and features of the invention will become more apparent from the following detailed description when taken in conjunction with the accompanying drawings.

### BRIEF DESCRIPTION OF THE DRAWINGS

FIG. 1 is a perspective view, partially cutaway, of a conventional shelf.

FIG. 2 is a sectional view of a clamping sleeve of the conventional shelf.

FIG. 3 is a perspective view of a work piece for forming a clamping sleeve in accordance with the present invention.

FIG. 4 is a perspective view of a device for shaping a U-shaped member accordance with the present invention.

FIG. 5 is an exploded perspective view of an apparatus for forming a clamping sleeve in accordance with the present invention.

FIG. 6 is a sectional view of the apparatus in accordance with the present invention.

FIG. 7 is a sectional view taken along plane 7-7 in FIG. 6.

FIG. 8 is a sectional view similar to FIG. 6, illustrating operation of the apparatus in accordance with the present invention.

FIG. 9 is a sectional view similar to FIG. 7 and taken along plane 9-9 in FIG. 8, illustrating operation of the apparatus in accordance with the present invention.

FIG. 10 is a perspective view of the clamping sleeve in accordance with the present invention.

FIG. 11 is a sectional view of the clamping sleeve in accordance with the present invention.

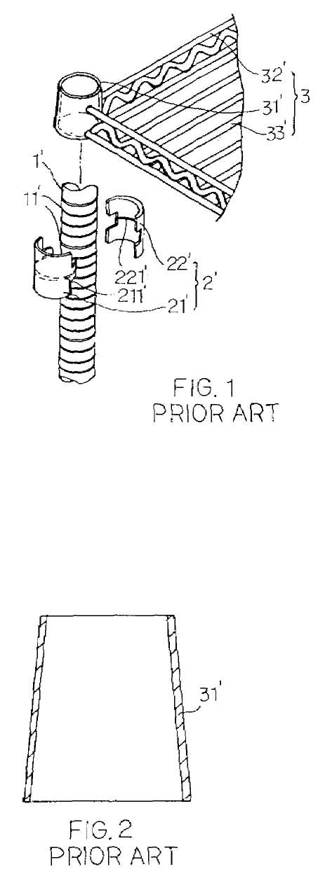

### DETAILED DESCRIPTION OF THE PREFERRED EMBODIMENT

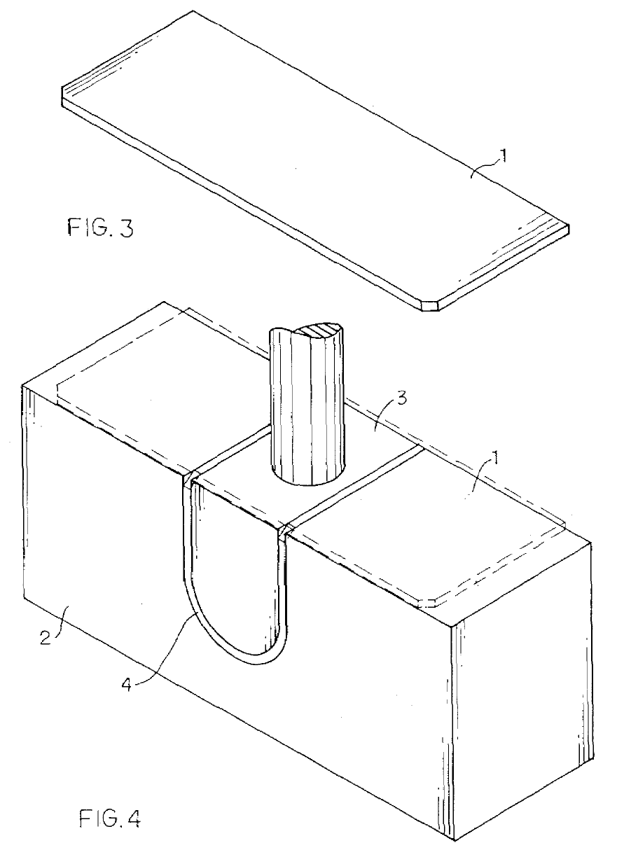

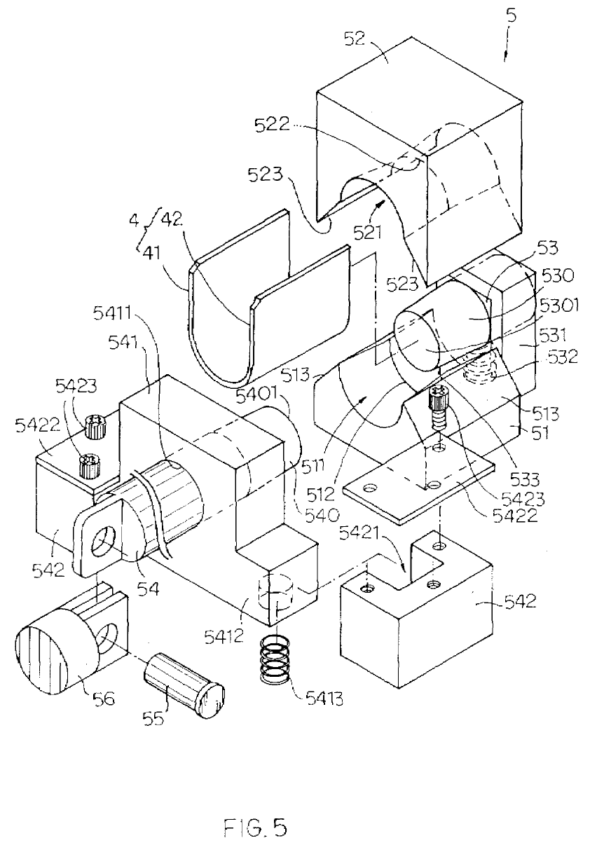

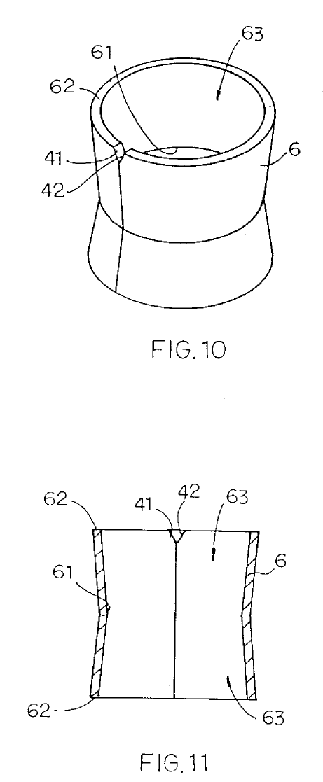

A method for manufacturing a clamping sleeve in accordance with the present invention comprises placing a metal plate 1 (see FIG. 3) in a shaping device 2 (see FIG. 4) and pressing the metal plate 1 into a U-shaped member 4 with a forming machine 3 (such as a pressing machine, see FIG. 4). The pressing machine 3 is conventional and therefore not illustrated in detail. The U-shaped member 4 includes two open ends. The U-shaped member 4 is then placed in an apparatus 5 (see FIG. 5) for forming a clamping sleeve 6 (see FIGS. 10 and 11). The apparatus 5 may be a pressing machine made of rigid material such as steel or the like.

Referring to FIG. 5, the apparatus 5 comprises a bottom mold 51, a top mold 52, a first inner mold 53, and a second inner mold 54. The bottom mold 51 includes a semi-circular groove 511 in a center thereof. The semi-circular groove 511 includes two open ends and a reduced section 512 between the open ends. An inclined face 513 is formed on each of two lateral sides of the bottom mold 51.

The top mold 52 is placed on top of the bottom mold 51 and includes a semi-circular groove 521 in a center thereof. The semi-circular groove 521 includes two open ends and a reduced section 522 between the open ends. The reduced section 522 of the top mold 52 is aligned with the reduced section 512 of the bottom mold 51. An inclined face 523 is formed on each of two lateral sides of the top mold 52.

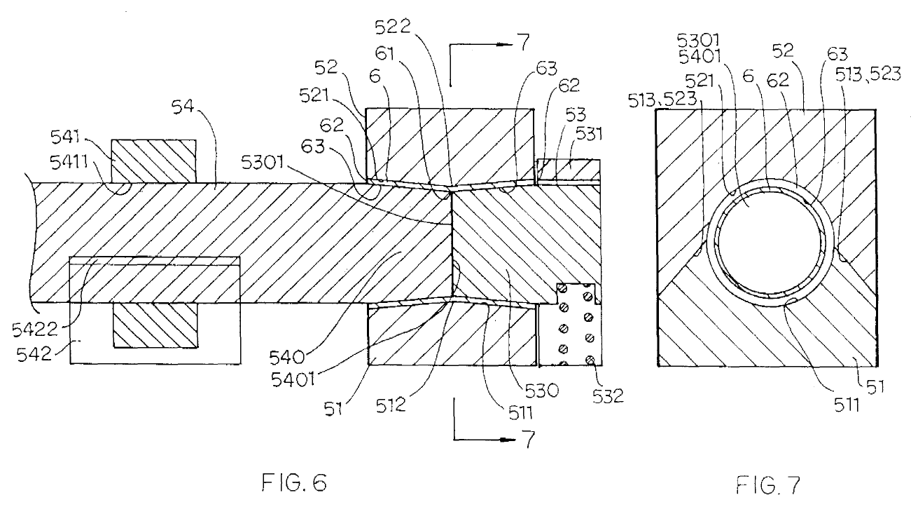

The top mold 52 can be moved by an actuating rod (not shown) in a direction to a position where the semi-circular grooves 511 and 521 of the bottom and top molds 51 and 52 together form a circle and where the inclined faces 523 of the top mold 52 are engaged with the respective inclined faces 513 of the bottom mold 51, as shown in FIGS. 6 and 7.

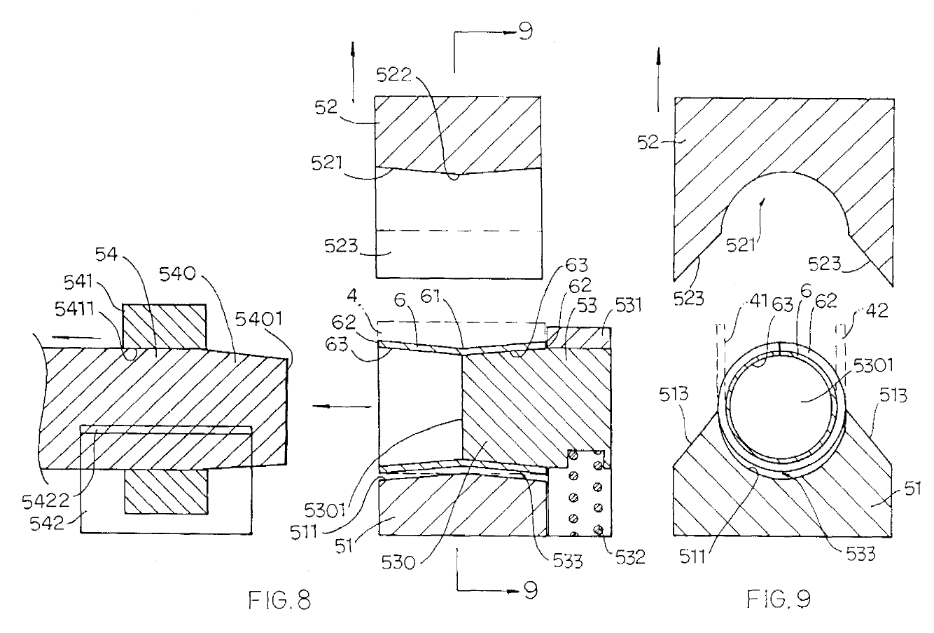

On the other hand, when the top mold 52 is moved by the actuating rod in a reverse direction, the semi-circular groove 521 of the top mold 52 is separate from the semi-circular groove 511 of the bottom mold 51 whereas the inclined faces 523 of the top mold 52 are disengaged from the respective inclined faces 513 of the bottom mold 51, as shown in FIGS. 8 and 9.

The first inner mold 53 is restrained in a frame 531 and, thus, cannot move back and forth. The first inner mold 53 includes a conic protrusion 530 that tapers outward and that extends into the semi-circular grooves 511 and 521 of the bottom and top molds 51 and 52. A front edge 5301 of the protrusion 530 of the first inner mold 53 rests at the reduced sections 512 and 522 of the bottom and top molds 51 and 52. The first inner mold 53 is biased by an elastic element 532 such that a gap 533 exists between the protrusion 530 and a circumferential wall defining the semi-circular groove 511 of the bottom mold 51, allowing insertion of a front half of the U-shaped member 4 into the gap 533.

An end of the second inner mold 54 adjacent to the first inner mold 53 includes a conic protrusion 540 that tapers outward. The other end of the second inner mold 54 is engaged with an actuating rod 56 by a pin 55. Hence, when the actuating rod 56 is moved outward, a front edge 5401 of the protrusion 540 is moved to the reduced sections 512 and 522 of the bottom and top molds 51 and 52. On the other hand, when the actuating rod 56 is retracted, the front edge 5401 of the protrusion 540 is disengaged from the semi-circular grooves 511 and 521 of the bottom and top molds 51 and 52. In order to allow rectilinear extension and retraction movements of the second inner mold 54, a slide block 541 is mounted adjacent to the protrusion 540 and has a hole 5411 in which the second inner mold 54 is slidingly received. The slide block 541 includes two wings 5412 respectively extending outward from two sides thereof. Each wing 5412 is engaged in an associated groove 5421 of a slide seat 542 and sealed by a lid 5422 screwed to the slide seat 542 (see fasteners 5423). An elastic element 5413 is provided below each wing 5412 for biasing the protrusion 540 of the second inner mold 54 on the slide block 541 into the U-shaped member 4 when the actuating rod 56 is moved outward.

Referring to FIGS. 5, 8, and 9, when the top mold 52 is not moved by the actuating rod (not shown), the second inner mold 54 is not moved (for the actuating rod 56 is not extended) such that the front edge 5401 of the protrusion 540 is located outside the semi-circular grooves 511 and 521 of the bottom and top molds 51 and 52. Further, the first inner mold 53 is biased by the elastic element 532 to provide a gap 533 that allows easy insertion of a front half of a U-shaped member 4, as indicated by the phantom lines in FIGS. 8 and 9.

On the other hand, when the actuating rod 56 is extended, the front edge 5401 of the protrusion 540 of the second inner mold 54 is moved to the reduced sections 512 and 522 of the bottom and top molds 51 and 52. The top mold 52 is then moved downward by the actuating rod (not shown). The inclined faces 523 of the top mold 52 press the end portions 41 and 42 of the U-shaped member 4 toward the first and second inner molds 53 and 54. Due to provision of the semi-circular grooves 511 and 521 of the bottom and top molds 51 and 52 and the protrusions 530 and 540 of the first and inner molds 53 and 54, the end portions 41 and 42 are pressed to join each other, forming a clamping sleeve 6 with an intermediate neck portion 61 and two open ends 62. An outwardly tapering conic coupling portion 63 is formed between the intermediate neck portion 61 and each open end 62, as shown in FIGS. 10 and 11.

When the actuating rod 56 is retracted, the front edge 5401 of the protrusion 540 of the second inner mold 54 is disengaged from the reduced sections 512 and 522 of the bottom and top molds 51 and 52. Next, the top mold 52 is moved upward by the actuating rod (not shown), separating the semi-circular groove 521 of the top mold 52 from the semi-circular groove 511 of the bottom mold 51. The clamping sleeve 6 (see the solid lines in FIGS. 8 and 9) can be easily removed. One of the outwardly tapering conic coupling sections 63 of the clamping sleeve 6 can be optionally used to allow pivotal movement.

Although a specific embodiment has been illustrated and described, numerous modifications and variations are still possible. The scope of the invention is limited by the accompanying claims.

What is claimed is:

1. An apparatus for forming a clamping sleeve for a shelf, comprising:
a bottom mold including a semi-circular groove in a center thereof, the semi-circular groove of the bottom mold including two open ends and a reduced section between the open ends, the bottom mold including two lateral sides each having an inclined face;
a top mold placed on top of the bottom mold and including a semi-circular groove in a center thereof, the semi-circular groove of the top mold including two open ends and a reduced section between the open ends, the reduced section of the top mold being aligned with the reduced section of the bottom mold, the top mold including two lateral sides each having an inclined face, the top mold being movable to a first position in which the semi-circular grooves of the top and bottom molds together form a circle whereas the inclined faces of the top mold are engaged with the inclined faces of the bottom mold and a second position in which the semi-circular grooves of the top and bottom molds are separate from each other whereas the inclined faces of the top mold are disengaged from the inclined faces of the bottom mold;
a first inner mold, the first mold being restrained in a frame and not moveable back and forth, the first inner mold including a conic protrusion that tapers outward and that extends into the semi-circular grooves of the bottom and top molds, a front edge of the protrusion of the first inner mold resting at the reduced sections of the bottom and top molds, the first inner mold being biased by an elastic element such that a gap exists between the protrusion of the first inner mold and a circumferential wall defining the semi-circular groove of the bottom mold, allowing insertion of a front half of a U-shaped member into the gap; and
a second inner mold including a first end adjacent to the first inner mold and a second end, the first end of the second inner mold including a conic protrusion that tapers outward, the second end of the second inner mold being engaged with an actuating rod by a pin;
wherein when the actuating rod is moved outward, a front edge of the protrusion of the second inner mold is moved to the reduced sections of the bottom and top molds; and
wherein when the actuating rod is retracted, the front edge of the protrusion of the second inner mold is disengaged from the semi-circular grooves of the bottom and top molds.

2. The apparatus as claimed in claim 1 further comprising:
a slide block mounted adjacent to the protrusion of the second inner mold and having a hole in which the second inner mold is slidingly received, the slide block including two wings respectively extending outward from two sides thereof;
a slide seat having two grooves, each said wing being engaged in an associated one of the grooves of the slide seat;
a lid screwed to the slide seat for sealing the slide block; and
an elastic element provided below each said wing for biasing the protrusion of the second inner mold into the U-shaped member when the actuating rod is moved outward.

3. A method for manufacturing a clamping sleeve for a shelf comprises pressing a metal plate into a U-shaped member with a forming machine and pressing the U-shaped member with an apparatus in accordance with claim 1 to form a clamping sleeve having an intermediate neck portion and two open ends, with an outwardly tapering conic coupling portion formed between the intermediate neck portion and each said open end.

4. A clamping sleeve for a shelf comprising an intermediate neck portion and two open ends, the clamping sleeve being formed by pressing a metal plate, with an outwardly tapering conic coupling portion formed between the intermediate neck portion and each said open end.
